(19) United States
(12) Patent Application Publication
(10) Pub. No.: US 2015/0253219 A1
(43) Pub. Date: Sep. 10, 2015

(54) METHOD AND ARRANGEMENT OF MEASURING A MECHANICAL BEARING OSCILLATION

(71) Applicant: AKTIEBOLAGET SKF, Göteborg (SE)

(72) Inventors: Joseph Erskine, Falkirk (GB); Keith Hamilton, Dunfermline (GB); Gerard McGoogan, Philipstourt West Lothian (GB); Tim Smith, Aberdour (GB); Allan Thomson, Libberton (GB); Andreas Clemens Van Der Ham, Utrecht (NL); Sebastian Ziegler, Utrecht (NL)

(21) Appl. No.: 14/395,164

(22) PCT Filed: Apr. 17, 2013
(86) PCT No.: PCT/EP2013/057969

§ 371 Date: Oct. 17, 2014

(30) Foreign Application Priority Data
Apr. 24, 2012 (US) 61637503

(51) Int. Cl. G01M 13/04; G01H 1/00

(52) U.S. Cl. CPC G01M 13/045; G01H 1/003

(57) ABSTRACT

An arrangement and a method of measuring a mechanical bearing oscillation within a bearing. The arrangement comprises: (1) a shaft adapted for rotating, coupled to an inner ring of the bearing, and supported by the bearing, wherein the bearing oscillation excites a shaft oscillation of the shaft; (2) a bolt having an outer threading portion screwed into the shaft in order to achieve a mechanical coupling for transferring the shaft oscillation to excite a bolt oscillation of the bolt; and (3) a sensor mechanically coupled to the bolt for registering the bolt oscillation, the bolt oscillation being indicative of the bearing oscillation.

### CROSS REFERENCE TO RELATED APPLICATIONS

This is a National Stage application claiming the benefit of International Application Number PCT/EP2013/057969 filed on 17 Apr. 2013 (17.04.2013), which claims the benefit of U.S. Provisional Patent Application No. 61/637,503 filed on 24 Apr. 2012, both of which are incorporated herein by reference in their entireties.

### FIELD OF THE INVENTION

Embodiments relate to a method and to an arrangement for measuring a mechanical bearing oscillation which in particular occurs during rotation of a wheel, such as a wheel of a bogie or carrier of a train.

### BACKGROUND

A mechanical bearing may support a rotation shaft to which a wheel is attached which may, for example, roll along and propagate along a railway. It may be desired to monitor the condition of the bearing during operation. Thereby, in condition monitoring it may be desired to measure vibrations or oscillations which originate from, for example, a rolling element bearing, for example, a bearing having rolling elements which are shaped as portions of cones, cylinders or spheres. Conventionally, a vibration sensor may be attached close to a vibration source by adhesive bonding or by a force fit to ensure a good transfer of the vibration between the target and the sensor surface.

Cast iron may be typically used for parts with complex geometries and high production volumes (such as motor blocks for combustion engines). As cast iron is resistant to oxidation, it is very popular and used frequently. However, cast iron structures have a relatively high vibration damping property due to carbon crystal(s) within the microstructure. Railway wheel end caps are typically manufactured from cast iron. However, the vibration damping or dampening property of cast iron, in particular, when used as a railway wheel end-cap, is unfavorable. In particular, the vibration dampening property dampens amplitudes of vibrations of the bearing before reaching a vibration sensor. Thus, the vibration sensor, in a conventional system, receives only relatively strongly decreased signal amplitudes due to the dampening of the oscillation via a transfer path involving the cast iron structure.

In these situations, conventionally, sensors with relatively high gain and expensive and complicated signal processing circuitry have been used in order to measure the bearing oscillation and acquire a corresponding measurement signal.

There is a need for an arrangement and a method for measuring a mechanical bearing oscillation which can reduce at least some of the above mentioned problems. In particular, there is a need for an arrangement and a method for measuring a mechanical bearing oscillation in situations, where materials or structures are present which have relatively high damping properties on mechanical oscillations or vibrations, in particular in the ultrasound frequency range.

### SUMMARY OF THE INVENTION

The need is solved by the independent claims which are directed to a method and an arrangement, respectively, for measuring a mechanical bearing oscillation. The dependent claims specify particular embodiments of the method and/or the arrangement.

It should be understood that features which are, individually, or in any combination, disclosed, described, mentioned or provided for a method of measuring a mechanical bearing oscillation are also applicable or can be provided for an arrangement of measuring a mechanical bearing oscillation according to an embodiment of the present invention, and vice versa.

According to an embodiment a method for measuring a mechanical bearing oscillation within a bearing is provided, wherein the bearing supports a rotating shaft (such as an axle for a wheel, in particular of a bogie or a carriage of a train) which is coupled to an inner ring of the bearing (e.g. a rolling element bearing comprising for example an inner ring, an outer ring, a cage and plural rolling elements between the inner ring and the outer ring and guided by the cage). Thereby, the method comprises
exciting, by the bearing oscillation, a shaft oscillation of the shaft,
exciting, by the shaft oscillation, a bolt oscillation of a bolt having an outer threading portion screwed into the shaft in order to achieve a mechanical coupling for transferring the shaft rotation, and
registering the bolt oscillation using a sensor mechanically coupled to the bolt, the bolt oscillation being indicative of the bearing oscillation.

The bearing may (radially outwards from the inner ring) comprise an outer ring which represents a fixed element (i.e. non-rotating element) during rotation of the shaft. In-between the inner ring and the outer ring plural rolling elements may be arranged which role during rotation of the shaft and which may cause excitation of the bearing oscillation, in particular in an ultrasound frequency range, such as a frequency range between 100 kHz and 500 kHz. The outer ring of the bearing may be fixed at a saddle adapter of a bogie or carriage of a train and the saddle adapter may in turn be fixed at a bogie of the carriage of the train. Axially (i.e. in the direction of the axis of the shaft) inwards from the bearing a wheel (in particular two wheels on the same shaft) may be fixedly attached or connected to the shaft such that the wheels rotate synchronously with the shaft. Also the inner ring of the bearing rotates synchronously with the rotation of the shaft. Furthermore, the bolt screwed into the shaft and also the sensor mechanically coupled to the bolt may rotate synchronously with the rotating shaft.

The bearing oscillation may be due to the rolling of the rolling elements between the inner ring and the outer ring of the bearing. The bearing oscillation may involve an oscillation of the outer ring, an oscillation of the rolling elements and/or an oscillation of the inner ring. The bearing oscillation may, due to the coupling between the shaft and the inner ring be transferred as a shaft oscillation to the shaft. In turn, the shaft oscillation may be transferred, due to the coupling between the bolt and the shaft, to the bolt as a bolt oscillation. The transfer of the bearing oscillation via the shaft and the bolt to the sensor may be achieved by a respective strong and tight coupling between the inner ring and the shaft, between the shaft and the bolt and between the bolt and the sensor and by using appropriate materials for the inner ring, the shaft, the bolt and any intermediate structure between the bolt and the sensor.

In particular, the bolt may be used to bridge a vibration or the oscillation from a steel part via a cast iron structure to the sensor unit. Thereby, the necessary surface for transmitting the vibration should preferably be at least a factor 0.5 of the inner screw diameter. The force between the first surfaces should preferably be at least 400 N/mm² multiplied with the surface of the bolt inner diameter. The sensor unit may thereby be arranged outside of the bearing unit which may allow an easy replacement of the sensor unit. In particular, the sensor unit may be retrofitted without modification of the end caps of the wheels. Thereby, the bolt may have two functions, i.e. to transfer the vibration or oscillation from the bearing to the sensor and to fix a cast iron part, such as an end cap, to the shaft.

Via the bolt so-called acoustic emission being a mechanical oscillation in the frequency range between 100 kHz and 500 kHz may be transferred from the source of the oscillation, i.e. the bearing, to the sensor. The sensor may in particular comprise a piezo-electric sensor or a MEM-sensor (MEM=Micro-Electro-Mechanical). In particular, a first side of the sensor may be mechanically coupled to the bolt, while a second side of the sensor may not attached to the bolt but may be free to oscillate in response to the first side being excited by the bolt oscillation. In particular, the first side may sense the bolt oscillation and a distance between the first side and the second side may change due to the bolt oscillation which in turn may, due to the piezoelectric effect, generate a voltage based on the changing distance. The voltage may change in accordance to or synchronously with the change of the distance, i.e. thereby reflecting the amplitude and the frequency of the bolt oscillation. Further, the bolt oscillation may essentially have a same frequency (or frequency range) as the bearing oscillation and may have an amplitude which may in particular linearly dependent on an amplitude of the bearing oscillation. Although the amplitude of the bolt oscillation may be smaller than the amplitude of the bearing oscillation, there may be a relatively low damping across the oscillation transfer path between the bearing and the sensor, in particular due to the bolt which may effectively transfer the shaft oscillation towards the sensor.

According to an embodiment an oscillation transfer path may be formed extending from the bearing via the shaft and bolt to the sensor, wherein the transfer path may be adapted to transfer the bearing oscillation such that an amplitude of the bolt oscillation is between 0.3 and 0.9, in particular between 0.5 and 0.7, times an amplitude of the bearing oscillation. Further, the oscillation transfer path may be such as not to change the frequency of the oscillation, i.e. a frequency (or frequency range) of the bearing oscillation may essentially be equal to a frequency (or frequency range) of the bolt oscillation which may then be transferred to the sensor without any change of the frequency.

Registering the bolt oscillation may further comprise electronic processing of primary sensor measurement signals. The processing of the primary sensor measurement signals may involve amplification, filtering, and so on, in particular to filter out disturbing signals which may result from the rotation of the sensor during the operation, since the sensor may rotate with a rotational speed of the shaft during registering the bolt oscillation. In particular, the rotation of the shaft may be at a relatively low frequency which may be effectively filtered out from the signals caused by the bearing oscillation which may lie in a higher frequency range.

For further condition monitoring a temperature sensor may be arranged, in particular close to the bolt or close to the vibration sensor. By providing the oscillation transfer path having a low damping effect it may be enabled to accurately measure a bearing oscillation using the sensor which is not directly in contact with the bearing but which is remote from the bearing and which is more easily accessible for maintenance, in particular replacement, service. The bolt may for example be a conventional bolt which may be used in a conventional carriage to fix an end cap onto the shaft.

According to an embodiment the bolt may be tightened with a sufficient pressure of between 100 N/mm̂2 to 1500 N/mm̂2, in particular between 200 N/mm̂2 to 1000 N/mm̂2, further in particular between 400 N/mm̂2 to 800 N/mm̂2, further in particular between 500 N/mm̂2 to 700 N/mm̂2, to the shaft, in order to achieve a strong mechanical coupling between the bolt and the shaft for effectively transferring the shaft rotation of shaft oscillation to the bolt oscillation. The pressure with which the bolt is tightened to the shaft should be below the limit pressure which is set for the bolt from the manufacturer.

According to an embodiment the bolt may comprise a contact surface in contact with the shaft which corresponds to (or is at least substantially equal to) between 0.3 and 5, in particular between 0.3 and 0.7, times a cross-sectional surface taken at the outer threading portion of the bolt. The contact surface may comprise portions within the threading of the bolt as well as portion of an end face (particularly axial end face) of the bolt at the threading portion. In particular, this end face may contact a shaft end face of an inner threading of the shaft. The bolt end face may press with a high force to the shaft inner threading end face, in order to achieve a strong mechanical coupling.

Further, another contact surface of the bolt may be present for contacting an intermediate structure between the bolt and the sensor in the case the sensor is not directly attached to the bolt, for example at the head of the bolt. In particular, when the intermediate structure is a metal sheet, or a washer, the other contact surface may be formed by a ring-shaped face of the head of the bolt which may press towards the sheet metal with a high pressure, as specified above, thereby generating a sufficient force for transferring the oscillation from the bolt to the intermediate structure, in particular the metal sheet.

According to an embodiment the bolt may be screwed into the shaft attaches a cap (in particular end cap) onto the shaft, wherein the sensor is located axially farther outwards from the shaft than a portion of the cap tightened by the bolt towards the shaft. Thereby, the bolt may serve two functions, first to transfer the oscillation to the sensor and second to fix and hold the cap at the shaft.

According to an embodiment the cap may have a higher damping effect on the oscillation than the bolt and the shaft, wherein the cap may comprise or may be made of cast iron. Thereby, the bolt may advantageously be used to bridge between the shaft and the sensor, to provide (a portion of) an oscillation transfer path.

According to an embodiment the method may further comprise coupling a metal sheet, in particular embodied as a washer, with the bolt due to tightening the bolt to the shaft, wherein the sensor is attached onto the metal sheet using glue, the cap being in particular located between the metal sheet and the shaft. The metal sheet may be pressed to the other contact surface of the bolt with a sufficiently high force, such as to effectively transfer the bolt oscillation to a metal sheet oscillation which may then be sensed by the sensor attached to the metal sheet. In particular, the metal sheet may have a sufficiently large area, in order to enable placement of the sensor onto the metal sheet.

Thereby, the sensor may in particular have a diameter between 4 and 8 mm and the sensor may have a height between 2 and 4 mm. Other sensor sizes may apply. The glue may in particular be adapted for effective transfer of the oscillation. Also a conventional washer may be utilized provided that the washer has a sufficiently large area for placement of the sensor. In particular, further circuitry such as a circuit board may be attached or placed at the metal sheet, e.g. circuitry for processing the sensor signal and/or for transmitting the sensor signals, in particular wirelessly, to a data acquisition equipment and further processing equipment which may be located within the carriage or within the train.

According to an embodiment (in particular instead of the metal sheet at which the sensor is located) the method may use a further screw having the sensor attached to the further screw using a glue, the further screw being screwed at the bolt. In this embodiment the further screw (and not the metal sheet) represents an intermediate structure between the bolt and the sensor which transfers the oscillation from the bolt to the sensor. It may be easier to first attach the sensor to the further screw and then screw the further screw into the bolt compared to the embodiment, where the sensor is directly attached to the screw. However, depending on the particular application, the sensor may as well be directly attached to the bolt, e.g. by gluing.

According to an embodiment the bolt may comprise an inner threading at a head of the bolt, in particular at a center of the head, the inner threading extending in the longitudinal direction of the outer threading of the bolt, wherein the further screw is screwed into the inner threading of the bolt. Thereby, a simple measure to fix the further screw at the bolt may be provided. Further, replacement or maintenance of the sensor may be easily applied.

According to an embodiment the glue (which may be used to attach the sensor to the metal sheet or to the further screw) may comprise hard metal particles, in particular comprising at least one of or a combination of the group of tungsten, W, tungsten carbide, W2C, WC, titanium nitride, TiN, titanium carbide, TiC, titanium carbide-nitride, Ti(C)N, titanium aluminum nitride, TiAlN, tantalum carbide TaC, cobalt, Co, and molybdenum, Mo, mixed with epoxy resin (which may in particular have been cross-linked). Due to the hard metal particles an effective transfer of the oscillation from the surface portions which are attached to each other may be achieved.

According to an embodiment the bolt may comprise or may be made of steel, in particular comprising Chromium (Cr) and/or Molybdenum (Mo) and/or Vanadium (V) and/or Nickel (Ni) and/or Niobium (Nb), in particular according to DIN 17111, DIN EN 10263-1, DIN EN 10087, DIN EN 10016-1, DIN EN 10084, DIN EN 10269 or DIN EN 10083, wherein DIN means “Deutsches Institut für Normung e.V.” (english: German Institute for Standardization). Thereby, these materials may provide an effective transfer of the oscillation, involving low damping.

According to an embodiment the inner ring of the bearing may comprise or may be made of steel, in particular comprising Cr of at least 1.5 wt % (wt %=weight percent), in particular comprising Carbon (C) between 0.1 wt % and 2 wt %, in particular comprising Cr and/or Mo, in particular according to ISO 683-17:1999, ISO 683-17:1999, EN 10088-1:1995, wherein ISO means “International Organization for Standardization”. That is to say, x wt % of a component in an alloy means that the component makes up x % of the alloy's mass or weight.

Thereby, the inner ring of the bearing may withstand stress during the operation and may further effectively transfer an oscillation of the bearing towards the shaft. In particular, the inner ring and the shaft may be welded together or may comprise a press fit.

According to an embodiment the sheet metal may comprise or may be made of steel, in particular cold rolled sheet of soft steel according to DIN EN 10130, warm rolled sheet metal from alloy or non-alloy steel according to DIN EN 10051, warm rolled sheet metal of construction steel according to DIN EN 10025, or stainless steel according to DIN EN 10088. Thereby, good oscillation transfer properties may be provided, in order to enable measurement of the oscillation using the sensor located remote from the bearing.

According to an embodiment the bearing oscillation transferred to the bolt as the bolt oscillation may have a frequency between 100 kHz and 500 kHz. This frequency range may also refer to as ultrasound range or acoustic emission range. The bearing condition may further be characterized by oscillation within a lower frequency range such as a range between 0 and 10 kHz. However, in this low frequency mechanical oscillation range the dampening effect of cast iron may be less pronounced such that a corresponding low frequency vibration sensor may possibly be placed onto the cast iron structure itself, for example at the end cap. In other embodiments also the low frequency vibration sensor may be placed onto the metal sheet or the further screw, depending on the particular application.

According to a further aspect it is provided an arrangement of measuring a mechanical bearing oscillation within a bearing. Thereby, the arrangement comprises a shaft adapted to rotate, coupled to an inner ring of the bearing, and supported by the bearing, wherein the bearing oscillation excites a shaft oscillation of the shaft (when the shaft is actually rotating). The arrangement further comprises a bolt having an outer threading portion screwed into the shaft (in particular into an inner threading of the shaft) in order to achieve a mechanical coupling for transferring the shaft oscillation to excite a bolt oscillation of the bolt. Further, the arrangement comprises a sensor mechanically coupled (in particular via a metal sheet or a further screw) to the bolt for registering the bolt oscillation, the bolt oscillation being indicative of the bearing oscillation.

Embodiments are now described with reference to the accompanying drawings. Note that embodiments of the present invention are not restricted to the described or illustrated embodiments.

### BRIEF DESCRIPTION OF THE DRAWING

FIG. 1 schematically illustrates a cross-sectional view of a portion of a railway truck or driving section comprising an arrangement of measuring a mechanical bearing oscillation according to an embodiment of the present invention which may be used in a method of measuring a mechanical bearing oscillation according to an embodiment of the present invention;

FIG. 2 schematically illustrates a cross-sectional view of a portion of a driving section comprising an arrangement of measuring a mechanical bearing oscillation according to another embodiment of the present invention which may be used in a method of measuring a mechanical bearing oscillation according to another embodiment of the present invention; and

FIG. 3 illustrates a portion of a railway truck comprising the arrangement illustrated in FIG. 1 or 2.

### DETAILED DESCRIPTION OF THE EMBODIMENTS

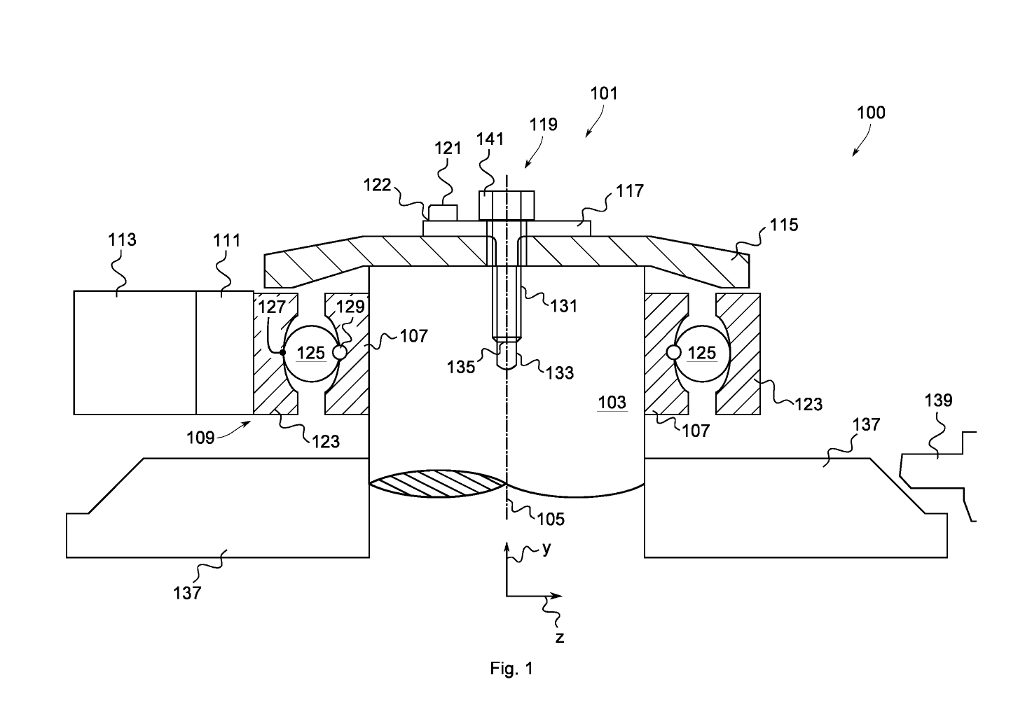

FIG. 1 schematically illustrates a portion of a driving section 100 of a railway truck which comprises an arrangement 101 of measuring a mechanical bearing oscillation according to an embodiment of the present invention. The arrangement 101 of measuring a mechanical bearing oscillation comprises a shaft 103 which is adapted for rotating around a rotation axis 105 which corresponds to y-axis. A z-axis is perpendicular to the y-axis and corresponds to a radial direction, while the y-axis (105) is also referred to as the axial direction. The shaft 103 is coupled to an inner ring 107 of a bearing 109, wherein the bearing 109 supports the shaft 103 relative to a saddle adapter 111 and a bogie 113 which are both fixed during operation, while the shaft rotates together with the inner ring 107, an end cap 115, a sheet metal 117, a bolt 119 and a sensor 121.

The bearing 109 comprises an outer ring 123 which is arranged radially outwards from the inner ring 107 and further a plurality of rolling elements 125 which may for example have a cone or cylinder type shape. Between contact surfaces of the inner ring 107 and the rolling element as well as between contact surfaces between the outer ring 123 and the rolling elements 125 a not illustrated lubricant is arranged for decreasing a friction force during operation. At contact areas or contact points 127, 129 between the rolling element 125 and the outer ring 123 or between the rolling element 125 and the inner ring 129, respectively, a vibration is generated during operation, i.e. while the shaft 103 is rotating.

An arrangement 101 according to an embodiment of the present invention is adapted for measuring an oscillation originating from the contact points or contact regions 127, 129, which oscillations may indicate a condition of the bearing 109. Therefore, the arrangement 101 of measuring a mechanical bearing oscillation comprises, beside the shaft 103, the bolt 119 having an outer threading portion 131 screwed into the shaft 103, in particular into an inner threading 133 of the shaft 103, in order to achieve a mechanical coupling for transferring the shaft oscillation to excite a bolt oscillation of the oscillation. In particular, the shaft oscillation is excited by the bearing oscillation generated due to the oscillations at the contact regions 127, 129. The bolt 119 transfers the bolt oscillation to the sheet metal 117, which may also be embodied as a washer, as a sheet metal oscillation. Furthermore, the sensor 121, such as a piezo-electric sensor, is glued onto the sheet metal 117, thereby causing the sheet metal oscillation to be transferred to the sensor 121. For effectively transferring the shaft oscillation to the bolt 119 the bolt 119 comprises a contact surface along the threading and also may comprise a contact surface at the end face 135 of the screw such that this end surface 135 firmly presses an inner end surface of the inner threading within the shaft 103.

The shaft 103 may extend in the axial direction (i.e. along the y-direction) and on another not illustrated portion of the shaft a further bearing may be provided for supporting the shaft at the other end. Fixed to the shaft is a wheel 137 which may contact a railway 139 during operation. On the other end of the shaft a further wheel may be arranged (which is not illustrated in FIG. 1).

The end cap 115 is manufactured from cast iron which has a pretty high damping effect on oscillations in the ultrasound region. The sheet metal 117 may act as a rail sensor mounting plate, wherein the sheet metal 117 (and/or the end cap 115) may be in particular machined such that a good mechanical coupling is achieved between the bolt 119 (in particular a face of a head 141 of the bolt 119) on one hand and to achieve a good mechanical coupling between the sheet metal 117 and the sensor 121 which may be glued onto the sheet metal 117 using glue which comprises hard metal particles mixed with a resin material. In particular, the sheet metal 117 may be attached to the shaft 103 using conventional bolt or bolts and conventional bolt holes in a train axle box. Thereby, the sheet metal 117 may be attached to the axle box without affecting any properties of the axle. In particular, the measuring arrangement 101 may be retrofitted in existing railway trucks. Advantageously, the sensor 121 may be easily accessible by a technician from outside without requiring disassembling portions of the railway truck or without requiring disassembling portions of the drive train.

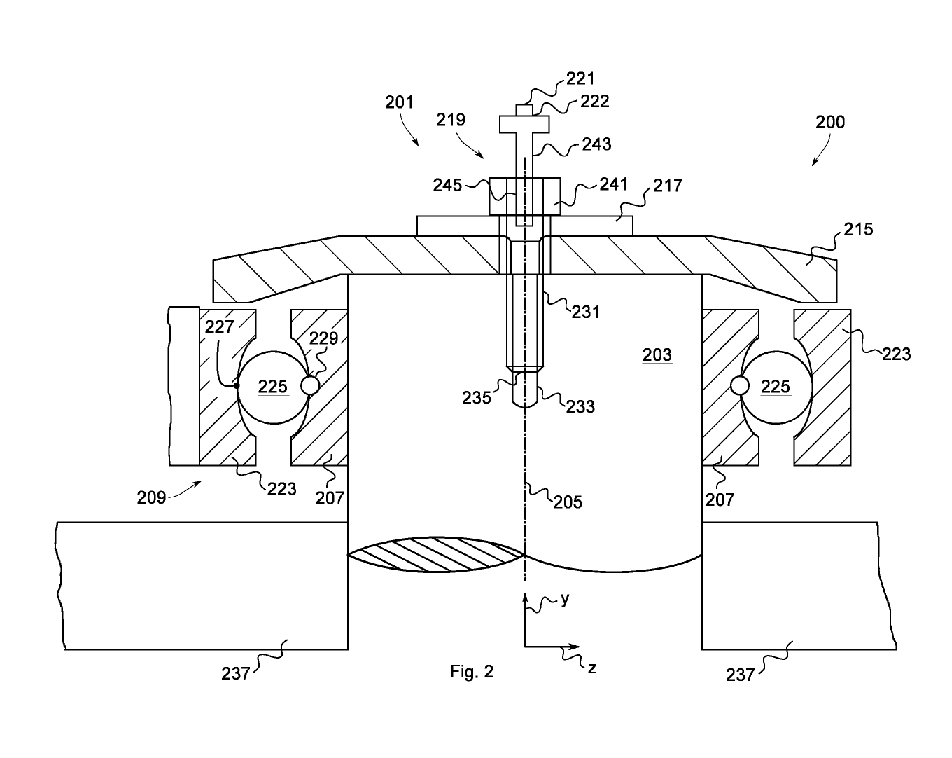

FIG. 2 illustrates schematically a cross-sectional view of a portion 200 of a drive train comprising an arrangement 201 of measuring a mechanical bearing oscillation according to another embodiment of the present invention. It should be noted that elements similar in structure and/or function in FIGS. 1 and 2 are labeled with the same reference numbers differing only in the first digit.

The arrangement 201 of measuring a mechanical bearing oscillation of a bearing 209 illustrated in FIG. 2 comprises a shaft 203, a bolt 219 and a sensor 221 as the arrangement 101 illustrated in FIG. 1. However, differing from the embodiment illustrated in FIG. 1, the sensor 221 is attached to a further screw 243 which is screwed into the bolt 219, in particular screwed into an inner threading 245 of the bolt 219 which is arranged in a central portion of the bolt 219, in the illustration at the rotation axis 205 of the shaft 203. In particular, the inner threading 245 of the bolt 219 extends in the axial direction 205, i.e. the y-direction. The sensor 221 is glued onto the head of the further screw 243. The description of other elements illustrated in FIG. 2 may be taken from the description relating to FIG. 1.

According to other embodiments the further screw 243 may be screwed into the bolt 219 at other locations of the bolt and along other direction than is indicated in FIG. 2.

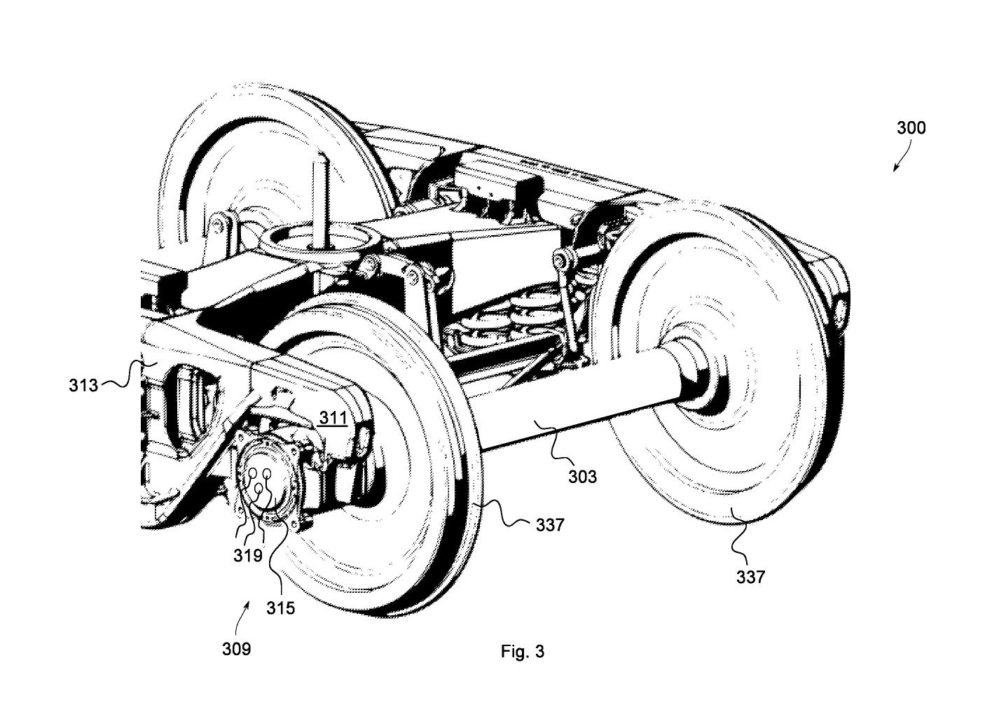

FIG. 3 illustrates a portion of a railway truck 300 in which an arrangement 101 or 201 of measuring a bearing oscillation may be integrated and in which a method of measuring a bearing oscillation according to an embodiment of the present invention may be performed.

Two wheels 337 are fixed at the shaft 303, wherein the shaft 203 is supported by a bearing 309 which is attached to a saddle adapter 311 which is in turn attached to a bogie 313. Also illustrated in FIG. 3 is the end cap 315 which is made from cast iron. The bearing 309 is partially occluded by the end cap 315. FIG. 3 further illustrates three bolts 319 which transfer a bearing oscillation to a not illustrated sensor mechanically coupled to the bolts 319. Details of the coupling between the bolts 319 and the not illustrated sensor can be taken from FIG. 1 or 2.

According to an embodiment the bolt may comprise or may be made of steel, in particular comprising Cr and/or Mo and/or V and/or Ni and/or Nb, in particular according to DIN 17111, DIN EN 10263-1, DIN EN 10087, DIN EN 10016-1, DIN EN 10084, DIN EN 10269 or DIN EN 10083. Thereby, these materials may provide an effective transfer of the oscillation, involving low damping.

The sheet metal 117 may be cold rolled or warm rolled steel sheet, e.g. according the regulations/rules: DIN EN 10130; DIN EN 10051; DIN EN 10025; DIN EN 10088

### REFERENCE SIGNS

100 portion of drive train
101 arrangement of measuring a bearing oscillation
103 shaft
105 shaft rotation axis
107 inner ring of bearing
109 bearing
111 saddle adapter
113 bogie
115 end cap
117 sheet metal
119 bolt
121 sensor
123 outer ring of bearing
125 rolling element
127, 129 contact regions of the bearing
131 outer threading portion of the bolt
133 inner threading of the shaft
135 end face of the threading portion of the bolt
137 railway wheel
139 railway
141 head of the bolt
243 further screw
245 inner threading of the bolt
2xx, 3xx as 1xx

1. A method for measuring a mechanical bearing oscillation within a bearing, the bearing supporting a rotating shaft which is coupled to an inner ring of the bearing, the method comprising:
exciting, by the bearing oscillation, a shaft oscillation of the shaft;
exciting, by the shaft oscillation, a bolt oscillation of a bolt having an outer threading portion screwed into the shaft in order to achieve a mechanical coupling for transferring the shaft oscillation; and
registering the bolt oscillation using a sensor mechanically coupled to the bolt, the bolt oscillation being indicative of the bearing oscillation.

2. The method according to claim 1, wherein an oscillation transfer path is formed extending from the bearing via the shaft and the bolt to the sensor, wherein the transfer path is adapted to transfer the bearing oscillation such that an amplitude of the bolt oscillation is between 0.3 and 0.9, times an amplitude of the bearing oscillation.

3. The method according to claim 1, wherein the bolt is tightened with a pressure of between 100 N/mm̂2 to 1500 N/mm̂2 to the shaft, in order to achieve a strong mechanical coupling between the shaft and the bolt.

4. The method according to claim 1, wherein the bolt comprises a contact surface in contact with the shaft which corresponds to between 0.3 and 5 times a cross-sectional surface taken at the outer threading portion of the bolt, the contact surface being in particular between 5 mm̂2 and 100 mm̂2.

5. The method according to claim 1, wherein the screwed bolt attaches a cap onto the shaft, wherein the sensor is located axially farther outwards from the shaft than a portion of the cap tightened by the bolt towards the shaft.

6. The method according to claim 5, wherein the cap provides a higher damping effect on the oscillation than the bolt and the shaft, wherein the cap comprises cast iron.

7. The method according to claim 1, further comprising a step of:
coupling a metal sheet, in particular embodied as a washer, with the bolt due to tightening the bolt to the shaft, wherein the sensor is attached onto the metal sheet using a glue, the cap being in particular located between the metal sheet and the shaft.

8. The method according to claim 1, further comprising a step of using a further screw having the sensor attached to the further screw using glue, the further screw being screwed at the bolt.

9. The method according to claim 8, wherein the bold comprises an inner threading at a head of the bolt, in particular at a center of the head, the inner threading extending in the longitudinal direction of the outer threading of the bolt, wherein the further screw is screwed into the inner threading of the bolt.

10. The method according to claim 1, wherein the glue comprises hard metal particles, the hard metal particles include at least one of tungsten, W, tungsten carbide, W2C, WC, titanium nitride, TiN, titanium carbide, TiC, titanium carbide-nitride, Ti(C)N, titanium aluminum nitride, TiAlN, tantalum carbide TaC, cobalt, Co, and molybdenum, Mo, mixed with epoxy resin.

11. The method according to claim 1, wherein the bolt comprises steel, the steel includes at least one of Cr, Mo, V, Ni, and Nb wherein the at least one of Cr, Mo, V, Ni, and Nb is in accordance with at least one of: DIN 17111, DIN EN 10263-1, DIN EN 10087, DIN EN 10016-1, DIN EN 10084, DIN EN 10269 and DIN EN 10083.

12. The method according to claim 1, wherein the inner ring of the bearing comprises steel, the steel includes Cr of at least 1.5 wt %, C between 0.1 wt % and 2 wt %, wherein at least one of Cr and Mo is in accordance with, ISO 683-17:1999, ISO 683-17:1999, and EN 10088-1:1995.

13. The method according to claim 1, wherein the sheet metal comprises steel.

14. The method according claim 1, wherein the bearing oscillation transferred to the bolt as the bolt oscillation has a frequency between 100 kHz and 500 kHz.

15. An arrangement for measuring a mechanical bearing oscillation within a bearing, the arrangement comprising:
a shaft adapted for rotating, coupled to an inner ring of the bearing, and supported by the bearing, wherein the bearing oscillation excites a shaft oscillation of the shaft;
a bolt having an outer threading portion screwed into the shaft in order to achieve a mechanical coupling for transferring the shaft oscillation to excite a bolt oscillation of the bolt; and
a sensor mechanically coupled to the bolt for registering the bolt oscillation, the bolt oscillation being indicative of the bearing oscillation.
